(19) United States
(12) Patent Application Publication
(10) Pub. No.: US 2009/0209699 A1
(43) Pub. Date: Aug. 20, 2009

(54) Method of producing a rubber composition

(76) Inventors: Hajo Weinreich, Hessisch Oldendorf (DE); Norbert Muller, Nienhagen (DE); Ulrike Ohnemuller, Wachenheim (DE); Carla Recker, Hannover (DE)

Correspondence Address: WALTER OTTESEN, PO BOX 4026, GAITHERSBURG, MD, 20885-4026, US

(21) Appl. No.: 12/292,873

(22) Filed: Nov. 28, 2008

(30) Foreign Application Priority Data
Feb. 20, 2008 (DE) 10 2008 010 111.7

(51) Int. Cl. C08L 9/06; C08L 9/00; C08C 19/25; C08L 11/00; C08L 7/00

(52) U.S. Cl. 524/572

(57) ABSTRACT

The invention is directed to a method of manufacturing a rubber composition with improved processing properties and optimized abrasion characteristics. Three methods with differing number of processing steps for the manufacture of a rubber composition with improved processing properties and optimized abrasion characteristics are disclosed.

### CROSS REFERENCE TO RELATED APPLICATION

This application claims priority of German patent application no. 10 2008 010 111.7, filed Feb. 20, 2008, the entire content of which is incorporated herein by reference.

### FIELD OF THE INVENTION

This application concerns a method of manufacturing a rubber mixture with improved processing characteristics and optimized wear properties.

### BACKGROUND OF THE INVENTION

The handling characteristics of a tire, especially of a vehicle tire, depend largely on the rubber composition of the tread, therefore, particularly high demands are imposed on the composition of the tread mixture. Many experiments have been conducted to positively influence the properties of the tire by varying the polymer components and the filler materials in the tread mixture. It is important to note that an improvement in one tire property often results in the impairment of another tire property. An improvement in wet grip often is accompanied by an impairment of the rolling resistance. To resolve the conflict between these two opposing tendencies, finely dispersed silica has proven effective as a filler in rubber mixtures with a diene elastomer or several diene elastomers. The improvement in rolling resistance due to the silica, however, results in increased abrasion and impairment of the heat build-up, which influences the handling of the tire. Silica is used alone or in combination with carbon black.

The incorporation of silica into the polymer matrix has a big impact on the properties of the resulting mixture and the vulcanized products derived therefrom. Distribution and incorporation can be influenced by using certain mixture components and the mixing method.

Ordinarily, the manufacture of a silica containing rubber composition occurs in two mixing steps, namely, the manufacture of a base mixture and a final mixture. During the manufacture of the base mixture, all the mixture constituents such as rubber, filler, processing agent, silane coupling reagent, aging inhibitor, ozone protecting agent and optionally an additional additive (with the exception of the vulcanizing reagents (sulfur, vulcanizing accelerator, resin and others)) are mixed under input of energy. Typically, one desires to disperse the components as quickly and uniformly as possible. Silica has a large specific hydrophilic surface area. To improve the processability and to obtain a better distribution of silica within the rubber composition, the constituents of the base mixture usually comprise coupling agents, especially in the form of silanes. These coupling agents make the silica surface more hydrophobic to allow chemical attachment to the surrounding rubber molecules in the subsequent vulcanization. After finishing the base mixture, its cooling and optionally its storage, the final mixture is prepared by adding the remaining ingredients, such as the vulcanization reagents, at a low temperature.

The related art is discussed in the following citations: German published patent applications DE 694 19 374 T2, DE 10 2005 057 801 A1, and DE 699 14 033 T2.

DE 694 19 374 T2 describes a tire with low rolling resistance in which a part of the carbon black comprised in the tread rubber mixture is replaced by a thermoplastic strengthening polymer, such as a polyamide or polypropylene. The strengthening polymer is added in the two-step method known in the rubber industry.

As an example of many further citations, DE 10 2005 057 801 A1 discusses rubber mixtures which contain one or more silanes. In that application, so-called mercaptosilanes are discussed, which have a better incorporation into the polymer matrix and which can, for environmental reasons, yield a reduced alcohol emission, especially of methanol and ethanol. In all the cases, the commonly used two-step mixing method is employed.

DE 699 14 033 T2 discloses a mixing method for the manufacture of a rubber mixture comprising 20-60 phr polyisoprene rubber, 40-80 phr butadiene rubber, 40-80 phr filler, wherein the filler contains 20-60 phr silica and 15-60 phr carbon black, at least one silica graft provider and 0-10 phr rubber processing oil. The method includes in the first step the mixture of the elastomer, carbon black, and optionally the oil, and, in a second step, silica and silica graft provider and optionally the processing oil are added. In the third step the sulfur vulcanization reagents are added.

The expression phr used in this application (parts per hundred parts of rubber by weight) is the measurement quantity for mixture compositions common in the rubber industry. The dosage of amounts of the individual components always refers to 100 parts of the entire mass of all the rubber components comprised in the composition.

### SUMMARY OF THE INVENTION

It is an object of the invention to provide three methods of manufacturing a rubber composition which result in improved processing properties with simultaneous optimization of the abrasion characteristics.

The methods of the invention comprise mixing the following:

a) a rubber, a mercaptosilane, a filler, an aging inhibitor, an ozone protecting wax, a softener, an inorganic activator, and a processing agent;

b) a sulfenamide accelerator, a thiazole accelerator, or a mixture thereof;

c) a further silane;

d) sulfur, a sulfur source, or a mixture thereof; and

e) a vulcanization accelerator to obtain a rubber blend; and vulcanizing the rubber blend.

The first method is characterized by two mixing steps and a subsequent vulcanization.

Components a), b), and c) are mixed in a first mixing; and components d) and e) are added to the mixture obtained in the first mixing and the resulting mixture is mixed in a second mixing to obtain the rubber blend, and the rubber blend is vulcanized to form the rubber composition.

The second method is characterized by three mixing steps and a subsequent vulcanization.

Components a) are mixed in a first mixing; components b) and c) are added to the mixture obtained in the first mixing and the resulting mixture is mixed in a second mixing; and components d) and e) are added to the mixture obtained in the second mixing and the resulting mixture is mixed in a third mixing to obtain the rubber blend, and the rubber blend is vulcanized to form the rubber composition.

The third method is characterized by three mixing steps and a subsequent vulcanization.

Components a) and b) are mixed in a first mixing; component c) is added to the mixture obtained in the first mixing and the resulting mixture is mixed in a second mixing; and components d) and e) are added to the mixture obtained in the second mixing and the resulting mixture is mixed in a third mixing to obtain the rubber blend, and the rubber blend is vulcanized to form the rubber composition.

### DESCRIPTION OF THE PREFERRED EMBODIMENTS OF THE INVENTION

The rubber is selected from the group comprising natural polyisoprene, synthetic polyisoprene, polyethylene, polybutadiene, styrene-butadiene copolymer, solution polymerized styrene-butadiene copolymer, emulsion polymerized styrene-butadiene copolymer, styrene-isoprene-butadiene-terpolymer, butyl rubber, halobutyl rubber, isoprene butyl rubber, ethylene-propylene diene rubber, chloroprene rubber, nitrile rubber, fluoro rubber, silicone rubber; or a mixture thereof.

In a preferred embodiment, the rubber is styrene-butadiene-rubber and in a very preferred embodiment the rubber is solution polymerized styrene-butadiene-rubber.

The rubber can be functionalized. Functionalization occurs via groups which can interact with fillers, especially with hydroxyl group containing fillers. Functionalization occurs by reaction with a hydroxyl group, an epoxy group, a siloxane group, an amino group, a phthalocyanine group, or a mixture thereof.

The rubber composition can also be un-functionalized, such that in the rubber composition all rubber components, some of the rubber components or no rubber component are functionalized.

The further silane has preferably the general formula Z-R¹—Sₙ—R¹-Z wherein n is an integer from 2 to 8, wherein Z is selected from the group consisting of:

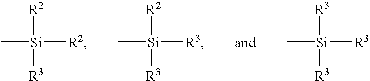

wherein R² is an alkyl group with 1 to 4 carbon atoms, a cycloalkyl group with 5 to 8 carbon atoms or a phenyl residue, and wherein R² can be the same or different within a molecule, R³ is an alkoxy group with 1 to 4 carbon atoms, a cycloalkoxy group with 5 to 8 carbon atoms or a phenoxy group, wherein R³ can be the same or different within a molecule, wherein R¹ is a substituted or unsubstituted, optionally polyunsaturated, optionally cyclic, alkylene group with 1 to 18 carbon atoms or a substituted or unsubstituted arylene group with a total of 6 to 12 carbon atoms and wherein R¹ can be the same or different within a molecule.

The further silane can also be selected from the silanes disclosed in U.S. patent application Ser. Nos. 11/617,649; 11/617,659; 11/617,663; 11/617,678; and, 11/617,683. The silanes known under the trade names NXT-type and NXT low VOC-type, available from Momentive Performance Materials Inc. can also be used.

In a preferred embodiment, the further silane is bis(triethoxysilylpropyl)disulfide (TESPD).

The amount of further silane is preferably between 0.5 and 15 phr, more preferably between 1 to 10 phr and most preferably between 2 to 7 phr.

All mercaptosilanes known to the skilled artisan can be used. The mercaptosilanes can be partially protected or unprotected.

In a preferred embodiment, the mercaptosilanes known from, for example, United States patent application publication US 2006/0161015 and international patent publication WO 2008/009514 are used. These are available under the trade name Si363 from Evonik Industries, but the silanes known under the trade name Si263 from Evonik Industries can also be used. The products known under the trade name NXT-Z-Type, available from Momentive Performance Materials Inc. can also be used.

The amount of mercaptosilane is preferably between 0.5 to 25 phr, more preferably between 1 to 18 phr and most preferably between 5 to 17 phr.

The vulcanization accelerator is selected from the group comprising sulfenamide accelerator, thiazole accelerator, and, preferably, mercapto accelerator.

In a preferred embodiment, the sulfenamide accelerator is benzothiazyl-2-cyclohexylsulfenamide (CBS) or benzothiazyl-2-tert-butylsulfenamide (TBBS). A combination of CBS and TBBS is also possible.

In another preferred embodiment, the thiazole accelerator, especially the mercapto accelerator, is 2-mercaptobenzothiazol (MBT) or dibenzothiazyldisulfide (MBTS). A combination of MBT and MBTS is also possible.

In addition, CBS, TBBS, MBT and MBTS can be combined with each other.

An additional vulcanization accelerator can be selected from the group comprising thiuram accelerator, dithiocarbamate accelerator, amine accelerator, dithiophosphate, thiourea, guanidine accelerator, and mixtures thereof. Sulfenamide accelerator and thiozol accelerator, especially mercapto accelerator, are herein excluded, in other words they are not comprised in the group of additional vulcanization accelerators.

The inventive method comprises mixing in either one filler or two fillers.

If the one filler is amorphous silica, it is used in an amount of 1 to 200 phr, preferably in an amount of 20 to 150 phr.

If the one filler is carbon black, the amount of carbon black is 1 to 120 phr, preferably 20 to 80 phr.

If two fillers are used, a combination of silica and carbon black is used having a total amount of 10 to 250 phr.

The addition of further fillers known to the skilled artisan is possible.

The first mixing takes place in a time frame of 0.3 to 20 minutes, preferably 0.5 to 10 minutes and more preferably 3 to 8 minutes at a temperature of 90 to 200° C., preferably 120 to 190° C., and more preferably at a temperature of from 130 to 170° C.

Vulcanization of the rubber blend takes place in the presence of sulfur or a sulfur source and some sulfur sources can also act as a vulcanization accelerator. Sulfur or sulfur sources are added in the last mixing step and are used in an amount customarily chosen by the skilled artisan (0.4 to 4 phr, sulfur is preferably used in an amount of 1.5 to 2.5 phr).

The rubber mixture obtained by any of the methods described herein can be used for the manufacture of tires. The tire can be a solid tire or a pneumatic tire for a vehicle. In particular, the rubber composition can be used for the tread of a vehicle pneumatic tire and for the body mixture of a vehicle pneumatic tire. The term body mixture comprises side wall, inner liner, apex, belt, shoulder, tread, squeegee, carcass, bead and/or ply.

High demands are also imposed on the abrasion performance of belts. Therefore, the inventive rubber composition is used for the manufacture of belts. This can be a conveyor belt, especially the mechanically stressed bottom cover of a conveyor belt, a V-belt, a ribbed V-belt, or a drive belt.

The invention is now explained with reference to comparative and exemplary embodiments without being restricted to these embodiments. Table 1a shows the respective mixing methods and the mixing constituents, whereas Table 1b shows the resulting physical properties of the rubber compositions based on optical inspection and test results obtained with several test specimens.

All the examples of mixtures displayed in Tables 1a and 1b show the amounts by weight, wherein 100 parts of weight correspond to the total amount of rubber.

Abbreviations MS1 and MS2 refer to mixing step 1 and mixing step 2.

The mixtures are made following the above-described methods with a laboratory tangential mixer. From all mixtures, test specimens were prepared by vulcanization and these test specimens were tested with material tests commonly used in the rubber industry. In the above tests on the test specimens, the following test methods were used:
Tangens Delta according to DIN 53 513 from a measurement with constant deformation amplitude of 0.2% with a 10% predeformation in compression with a 10 Hz dynamic deformation frequency
abrasion at room temperature according to DIN 53 516
subjective, optical assessment of the rubber sheet after mixing and rolling out (1=smooth (very good), 5=crumbly (unsatisfactory)

TABLE 1a

| | | V1 | V2 | E1 | E2 |
|---|---|---|---|---|---|
| MS1 | SSBR | 70 | 70 | 70 | 70 |
| | NR | 30 | 30 | 30 | 30 |
| | Silane 1 | 8 | — | — | 2.5 |
| | Silane 2 | — | 8.8 | 8.8 | 8.8 |
| | Silica | 86 | 86 | 86 | 86 |
| | Carbon Black | 5 | 5 | 5 | 5 |
| | Softener | 25 | 25 | 25 | 25 |
| | Anti-Aging Agent | 2 | 2 | 2 | 2 |
| | Ozone Protecting Wax | 2 | 2 | 2 | 2 |
| | Activator | 3 | 3 | 3 | 3 |
| | Stearic Acid | 2 | 2 | 2 | 2 |
| | CBS | — | — | 2.7 | 2.7 |
| MS2 | DPG | 2 | 0.3 | 0.3 | 0.3 |
| | CBS | 2 | 2.7 | — | — |
| | TBzTD | — | 0.5 | 0.5 | 0.5 |
| | Sulfur | 1.7 | 1.7 | 1.7 | 1.7 |

SSBR: NIPOL NS116R, Fa. Nippon Zeon
Silane 1: SILQUEST A-1589 SILANE, General Electric Speciality, USA
Silane 2: Mercaptosilane, Si 363, Degussa AG, Germany
Silica: VN3, nitrogen-surface area: 175 m²/g, CTAB-surface area 160 m²/g; Degussa AG, Germany
Carbon Black: N339
Softener: Mineral Oil, MES
DPG = N,N-Diphenylguanidine
CBS = Benzothiazyl-2-cyclohexylsufenamide
TBzTd = Tetrabenzylthiuramdisulfide

TABLE 1b

| | Unit | V1 | V2 | E1 | E2 |
|---|---|---|---|---|---|
| Sheet properties (optical) | | 1 | 4.5 | 1.5 | 1 |
| Tan δ at −15° C. | | 0.74 | 0.86 | 0.85 | 0.83 |
| Tan δ at +55° C. | | 0.166 | 0.153 | 0.155 | 0.154 |
| Abrasion | mm³ | 111 | 126 | 144 | 95 |

As can be seen from the results in Tables 1a and 1b, the addition of a mercaptosilane in combination with a sulfenamide accelerator in the first mixing step, see E1, results in improvement of the processability. The rolled out rubber sheet is considerably smoother and therefore easier to process compared to adding only a mercaptosilane in the first mixing step, see V2. By comparing E1 to examples V1 and V2, abrasion worsens by 23% relative to V1 and 11% relative to V2. In comparison to V2, which contains a mercaptosilane without the addition of a sulfenamide accelerator in the first mixing step, values for wet grip and rolling resistance remain at the same level for a combined addition, see E1. Wet grip is measured by measuring tan δ at −15° C., whereas rolling resistance is measured as tan δ at +55° C. In the first case, higher values indicate an improvement, whereas, in the second case, lower values indicate an improvement.

To correct the worsening of abrasion, a further silane is added in addition to the mercaptosilane and the sulfenamide accelerator in the first mixing step, see E2. Abrasion improves by comparison to V1 by about 17% and additionally an optimization with regard to the processing properties (sheet formation) takes place.

The terms “a” and “the” as used herein are understood to encompass the plural as well as the singular. All publications, patents and patent applications cited in this specification are herein incorporated by reference and for any and all purpose, as if each individual publication, patent or patent application were specifically and individually indicated to be incorporated by reference. In the case of inconsistencies, the present disclosure will prevail.

It is understood that the foregoing description is that of the preferred embodiments of the invention and that various changes and modifications may be made thereto without departing from the spirit and scope of the invention as defined in the appended claims.

What is claimed is:

1. A method of manufacturing a rubber composition, comprising:
mixing,
a) a rubber, a mercaptosilane, a filler, an aging inhibitor, an ozone protecting wax, a softener, an inorganic activator, and a processing agent;
b) a sulfenamide accelerator, a thiazole accelerator, or a mixture thereof;
c) a further silane;
d) sulfur, a sulfur source, or a mixture thereof, and
e) a vulcanization accelerator to obtain a rubber blend; and vulcanizing the rubber blend.

2. The method of manufacturing a rubber composition according to claim 1, wherein components a), b), and c) are mixed in a first mixing; and components d) and e) are added to the mixture obtained in the first mixing and the resulting mixture is mixed in a second mixing to obtain the rubber blend.

3. A method of manufacturing a rubber composition according to claim 1, wherein components a) are mixed in a first mixing; components b) and c) are added to the mixture obtained in the first mixing and the resulting mixture is mixed in a second mixing; and components d) and e) are added to the mixture obtained in the second mixing and the resulting mixture is mixed in a third mixing to obtain the rubber blend.

4. A method of manufacturing a rubber composition according to claim 1, comprising: components a) and b) are mixed in a first mixing; component c) is added to the mixture obtained in the first mixing and the resulting mixture is mixed in a second mixing; and components d) and e) are added to the mixture obtained in the second mixing and the resulting mixture is mixed in a third mixing to obtain the rubber blend.

5. The method according to claim 1, wherein the rubber is selected from the group comprising: natural polyisoprene, synthetic polyisoprene, polyethylene, polybutadiene, styrene-butadiene copolymer, solution polymerized styrene-butadiene copolymer, emulsion polymerized styrene-butadiene copolymer, styrene-isoprene-butadiene-terpolymer, butyl rubber, halobutyl rubber, isoprene butyl rubber, ethylene-propylene diene rubber, chloroprene rubber, nitrile rubber, fluoro rubber, and silicone rubber; or a mixture thereof.

6. The method according to claim 1, wherein the rubber is a styrene-butadiene rubber.

7. The method according to claim 1, wherein the rubber is a solution polymerized styrene-butadiene rubber.

8. The method according to claim 1, wherein the rubber is functionalized.

9. The method according to claim 7, wherein the rubber is functionalized with a moiety from the group consisting of hydroxyl-, epoxy, silane, amino, and phthalocyanin; or a mixture thereof.

10. The method according to claim 1, wherein the rubber is not functionalized.

11. The method according to claim 1, wherein the silane is bis (triethoxysilylpropyl) disulfide (TESPD).

12. The method according to claim 1, wherein the amount of mercaptosilane is of from 0.5 parts per hundred (phr) to 25 phr.

13. The method according to claim 1, wherein the amount of mercaptosilane is of from 1 phr to 18 phr.

14. The method according to claim 1, wherein the amount of mercaptosilane is of from 5 phr to 17 phr.

15. The method according to claim 1, wherein the amount of mercaptosilane is of from 0.5 phr to 15 phr.

16. The method according to claim 1, wherein the amount of silane is of from 1 phr to 10 phr.

17. The method according to claim 1, wherein the amount of silane is of from 2 phr to 7 phr.

18. The method according to claim 1, wherein the sulfenamide accelerator is benzothiazyl-2-cyclohexylsulfeneamide (CBS), benzothizayl-2-tert-butylsulfenamide (TBBS), or a mixture thereof.

19. The method according to claim 1, wherein the thiazole accelerator is 2-mercaptobenzothiazol, dibenzothiazyldisulfid, or a mixture thereof.

20. The method according to claim 1, wherein the vulcanization accelerator is selected from a thiuram accelerator, a dithiocarbamate accelerator, an amine accelerator, a dithiophosphate accelerator, a thiocarbamate accelerator, a guanidine accelerator; or a mixture thereof.

21. The method according to claim 1, wherein one filler is used.

22. The method according to claim 1, wherein the filler is amorphous silica.

23. The method according to claim 22, wherein the amount of amorphous silica is of from 1 to 200 phr.

24. The method according to claim 22, wherein the amount of amorphous silica is of from 20 to 150.phr.

25. The method according to claim 1, wherein the filler is a carbon black.

26. The method according to claim 25, wherein the amount of carbon black is of from 1 to 120 phr.

27. The method according to claim 26, wherein the amount of carbon black is of from 20 to 80 phr.

28. The method according to claim 1, wherein two fillers are used.

29. The method according to claim 28, wherein the fillers are carbon black and amorphous silica.

30. The method according to claim 29, wherein the total amount of the two fillers is of from 10 to 250 phr.

31. The method according to claim 1, wherein a duration of the mixing is of from 0.3 to 20 minutes.

32. The method according to claim 31, wherein the duration of the mixing is of from 0.5 to 10 minutes.

33. The method according to claim 31, wherein a duration of the mixing is of from 3 to 8 minutes.

34. The method according to claim 1, wherein the mixing occurs at a temperature of from 90° C. to 200° C.

35. The method according to claim 34, wherein the mixing occurs at a temperature of from 120° C. to 190° C.

36. The method according to claim 34, wherein the mixing occurs at a temperature of from 130° C. to 170° C.

37. A process for making a car tire comprising manufacturing the rubber composition according to the method of claim 1.

38. A process for making a tread for a car tire comprising manufacturing the rubber composition according to the method of claim 1.

39. A process for making a body-mixture for a pneumatic tire comprising manufacturing the rubber composition according to the method of claim 1.

40. A process for making a body-mixture for a pneumatic tire including sidewall, apex, belt, shoulder, tread, squeegee, carcass, bead, and ply comprising manufacturing the rubber composition according to the method of claim 1.

41. A process for making a belt comprising manufacturing the rubber composition according to the method of claim 1.

42. A process for making a conveyor belt or a bottom cover for a conveyor belt comprising manufacturing the rubber composition according to the method of claim 1.

43. A process for making a v-belt, a ribbed v-belt, or a timing belt comprising manufacturing the rubber composition according to the method of claim 1.
